(19) United States
(12) Patent Application Publication
(10) Pub. No.: US 2020/0296274 A1
(43) Pub. Date: Sep. 17, 2020

(54) IMAGE CAPTURING APPARATUS AND METHOD FOR CONTROLLING SAME, AND STORAGE MEDIUM

(71) Applicant: CANON KABUSHIKI KAISHA, Tokyo (JP)

(72) Inventor: Takashi Ichimiya, Yokohama-shi (JP)

(21) Appl. No.: 16/813,979

(22) Filed: Mar. 10, 2020

(30) Foreign Application Priority Data
Mar. 14, 2019 (JP) 2019-047338

(51) Int. Cl. H04N 5/235; H04N 5/225

(52) U.S. Cl. CPC H04N 5/2352; H04N 5/2254

(57) ABSTRACT

An image capturing apparatus includes a two-dimensional imaging sensor having a first imaging area and a second imaging area respectively receiving light having passed through a first pupil area and a second pupil area, a calculation unit configured to add pixels in the first imaging area in a predetermined direction that differs from two directions, which are the correlation calculation direction and a direction perpendicular to the correlation calculation direction, to form a first line signal in which the added pixels line up in the correlation calculation direction, to add pixels in the second imaging area in the predetermined direction to form a second line signal in which the added pixels line up in the correlation calculation direction, and to perform a correlation calculation using the first line signal and the second line signal.

### BACKGROUND OF THE INVENTION

### Field of the Invention

The present invention relates to a focal point detection technique in an image capturing apparatus.

### Description of the Related Art

Conventionally, image capturing apparatuses are required to have automatic focal point detection functions, and image capturing apparatuses provided with an automatic focal point detection function of the phase difference detection method are popular. The phase difference detection method is a method in which light from an object is divided into two images (a pair of images) by a separator lens (spectacle lens), and the focus state is detected from the phase difference between the two images.

Japanese Patent Laid-Open No. 2018-29342 discloses a focal point detection apparatus in which each pixel constituting an area sensor includes four photoelectric conversion units, and which is capable of detecting the focus state of an object in a plurality of correlation calculation directions such as the vertical, horizontal, and oblique directions by forming pairs of images by changing combinations of the photoelectric conversion units.

However, with the prior art disclosed in Japanese Patent Laid-Open No. 2018-29342, when focusing on a combination of photoelectric conversion units (referred to hereinafter as pixels) having an oblique correlation calculation direction, there are cases in which a large focal point detection error occurs due to the pixels having rhombus shapes and being adjacent to one another. This will be described in further detail.

FIG. 10 is a diagram illustrating the positional relationship of pixels in an oblique direction in the prior art. Here, an A image and a B image constitute a pair of images, and there is a half-pixel shift between the phase of the A image and the phase of the B image. When there is a thin line at a position adjacent to a corner of a pixel in the B image as illustrated in FIG. 10, a pixel in the A image receives light from the thin line near the center of the pixel, and thus, can detect the contrast of the thin line. On the other hand, in the pixel in the B image, the thin line is located at an edge of the pixel, and thus, the pixel in the B image cannot detect the contrast of the thin line. Even if the thin line is located at a position other than the position illustrated in FIG. 10, the light receiving amounts of the A image and the B image vary considerably depending on the position of the object with contrast, i.e., the thin line, and a large phase difference detection error occurs.

### SUMMARY OF THE INVENTION

The present invention has been made in view of the above-described problem, and provides an image capturing apparatus that can perform focal point detection with high accuracy even for an object with contrast in an oblique direction.

According to a first aspect of the present invention, there is provided an image capturing apparatus comprising: a two-dimensional imaging sensor having a first imaging area and a second imaging area respectively receiving light having passed through a first pupil area and a second pupil area that are obtained by dividing a pupil area of an imaging lens in a correlation calculation direction; and at least one processor or circuit configured to function as a calculation unit configured to add pixels in the first imaging area in a predetermined direction that differs from two directions, which are the correlation calculation direction and a direction perpendicular to the correlation calculation direction, to form a first line signal in which the added pixels line up in the correlation calculation direction, to add pixels in the second imaging area in the predetermined direction to form a second line signal in which the added pixels line up in the correlation calculation direction, and to perform a correlation calculation using the first line signal and the second line signal.

According to a second aspect of the present invention, there is provided a method for controlling an image capturing apparatus including a two-dimensional imaging sensor having a first imaging area and a second imaging area respectively receiving light having passed through a first pupil area and a second pupil area that are obtained by dividing a pupil area of an imaging lens in a correlation calculation direction, the method comprising: adding pixels in the first imaging area in a predetermined direction that differs from two directions, which are the correlation calculation direction and a direction perpendicular to the correlation calculation direction, to form a first line signal in which the added pixels line up in the correlation calculation direction; adding pixels in the second imaging area in the predetermined direction to form a second line signal in which the added pixels line up in the correlation calculation direction; and performing a correlation calculation using the first line signal and the second line signal.

Further features of the present invention will become apparent from the following description of exemplary embodiments with reference to the attached drawings.

### BRIEF DESCRIPTION OF THE DRAWINGS

FIG. 1 is a lateral view of a digital camera that is a first embodiment of the image capturing apparatus of the present invention.

FIG. 2 is a perspective view schematically illustrating the configuration of a focal point detection optical system in the first embodiment.

FIG. 3 is a circuit diagram of a focal point detection sensor in the first embodiment.

FIG. 4 is a diagram illustrating drive timings of the focal point detection sensor in the first embodiment.

FIG. 5A is an enlarged view of an imaging area on the focal point detection sensor in the first embodiment.

FIG. 5B is an enlarged view of an imaging area on the focal point detection sensor in the first embodiment.

FIG. 5C is an enlarged view of an imaging area on the focal point detection sensor in the first embodiment.

FIG. 6 is a flowchart for describing operations of the camera in the first embodiment.

FIG. 7 is a flowchart for describing operations in focal point adjustment processing in the first embodiment.

FIG. 8 is a perspective view schematically illustrating the configuration of a focal point detection optical system in a second embodiment.

FIG. 9 is a plan view illustrating some pixels of an image sensor in the second embodiment in isolation.

FIG. 10 is a diagram illustrating the positional relationship of pixels in an oblique direction in the prior art.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

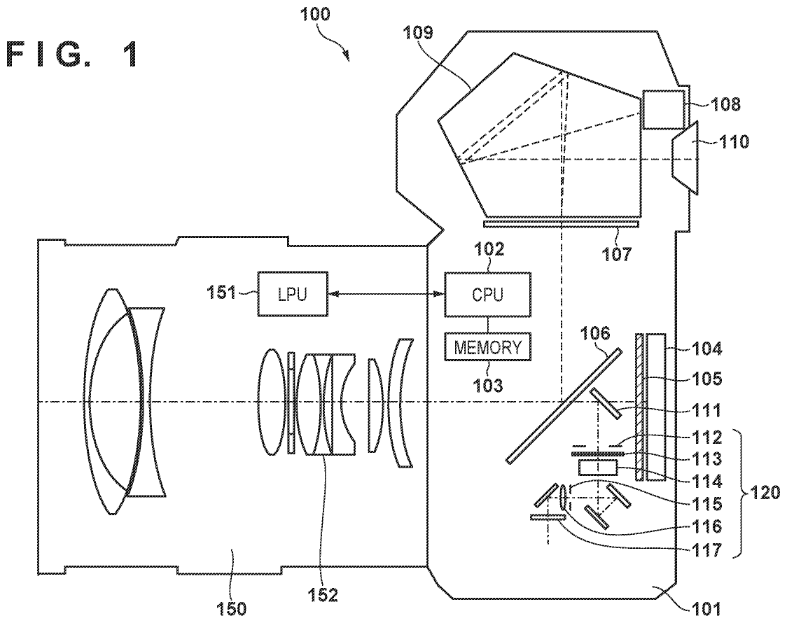

FIG. 1 is a lateral view of a digital camera that is a first embodiment of the image capturing apparatus of the present invention.

In FIG. 1, a digital camera 100 includes a camera main body 101 and a lens (imaging lens) 150. Note that the internal configuration is illustrated in perspective in FIG. 1 to facilitate understanding of the description. The camera main body 101 includes a CPU 102, a memory 103, an image sensor 104, a shutter 105, a half mirror 106, a focus plate 107, a photometric sensor 108, a pentaprism 109, an optical finder 110, and a sub mirror 111. Furthermore, the camera main body 101 includes a focal point detection unit 120, which includes a visual field mask 112, an infrared cut filter 113, a field lens 114, an aperture 115, a secondary imaging lens 116, and a focal point detection sensor (sensor for focal point detection) 117. The lens 150 includes an LPU 151 and a lens group 152.

The CPU 102 is constituted by a microcomputer, and executes the different types of control performed in the camera main body 101. The memory 103 is a memory such as a RAM or ROM connected to the CPU 102, and stores data and programs to be executed by the CPU 102. The image sensor 104 is constituted by a CCD, CMOS sensor, or the like that includes an infrared cut filter, a low pass filter, or the like, and images light entering through the lens 150 as an object image. The shutter 105 can be driven to open and close. The shutter 105 closes and blocks light to the image sensor 104 when shooting is not performed, and opens and exposes the image sensor 104 to light when shooting is performed. The half mirror 106, when shooting is not performed, reflects part of the light entering through the lens 150 and images the light on the focus plate 107. The photometric sensor 108 includes an image sensor such as a CCD or CMOS sensor, and performs photographic-subject recognition processing such as a photometric operation, a face detection operation, a tracking operation, and light source detection. The pentaprism 109 reflects light passing through the focus plate 107 toward the photometric sensor 108 and the optical finder 110.

Furthermore, the half mirror 106 transmits part of the light entering through the lens 150. The transmitted light is bent downward by the sub mirror 111 located on the rear side of the half mirror 106, and, after passing through the visual field mask 112, the infrared cut filter 113, the field lens 114, the aperture 115, and the secondary imaging lens 116, the light is imaged on the focal point detection sensor 117, in which photoelectric conversion elements are two-dimensionally disposed. The focal point detection unit 120 detects the focus state of the lens 150 based on image signals obtained by photoelectrically converting this image.

The LPU 151 is constituted by a microcomputer, and executes control for moving the lens group 152 in the lens 150. For example, the LPU 151, upon receiving a defocus amount indicating the amount of divergence of focus from the CPU 102, moves the lens group 152 to an in-focus position (referred to hereinafter as “focusing position”) based on the defocus amount.

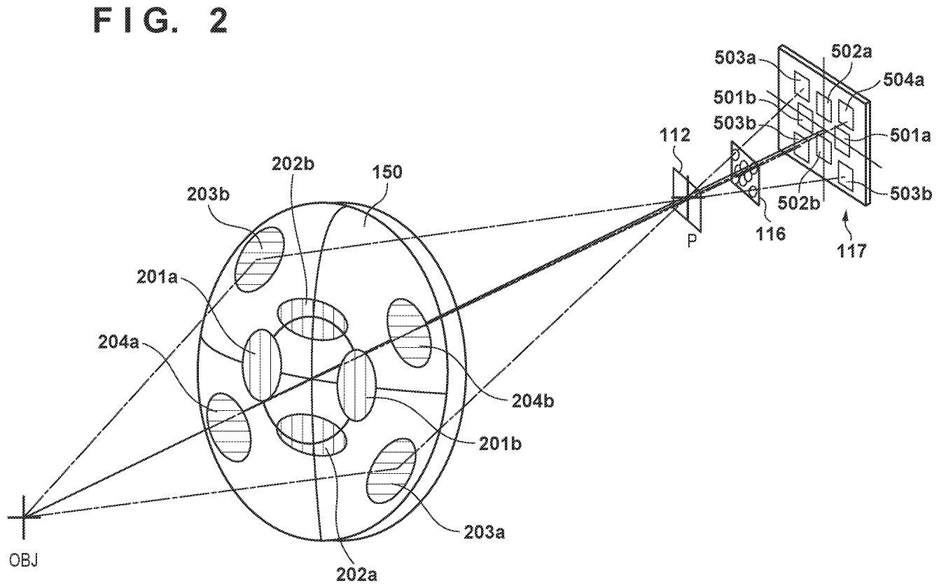

FIG. 2 is a perspective view schematically describing light beams in the focal point detection system.

In FIG. 2, light beams from an object OBJ pass through a plurality of pupil areas of the lens 150, and are imaged on a focus plane P (primary imaging surface) near the visual field mask 112. The object image imaged on the primary imaging surface is divided into a plurality of pairs of images by the secondary imaging lens 116, which is constituted by a plurality of separator lenses (spectacle lenses), and is re-imaged on the focal point detection sensor 117. A defocus amount can be calculated by performing a correlation calculation on pairs of images photoelectrically converted by this focal point detection sensor 117.

Out of the plurality of light beams from the object OBJ, the light beams passing through pupil areas 201a and 201b are imaged on two imaging areas of the focal point detection sensor 117 which have a horizontal-direction correlation, namely the imaging areas 501a and 501b. Out of the plurality of light beams from the object OBJ, the light beams passing through pupil areas 202a and 202b are imaged on two imaging areas of the focal point detection sensor 117 which have a vertical-direction correlation, namely the imaging areas 502a and 502b.

Out of the plurality of light beams from the object OBJ, the light beams passing through pupil areas 203a and 203b are imaged on two imaging areas, namely the imaging areas 503a and 503b, and the light beams passing through pupil areas 204a and 204b are imaged on two imaging areas, namely the imaging areas 504a and 504b. These imaging areas have an oblique-direction correlation (correlation in a diagonal direction of pixels).

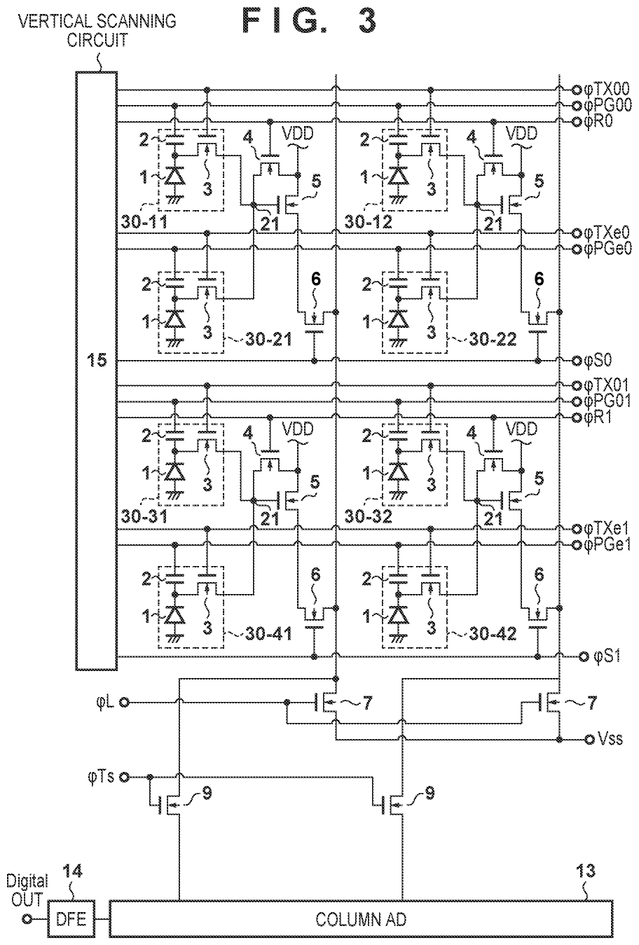

FIG. 3 is a diagram illustrating the configuration of the focal point detection sensor 117 in the first embodiment.

The focal point detection sensor 117 is a two-dimensional C-MOS area sensor, and some of the pixels (an area corresponding to 2 columns×4 rows of pixels) of the focal point detection sensor 117 are illustrated in FIG. 3 to facilitate understanding of the description. In actuality, a large number of the pixels illustrated in FIG. 3 are disposed to enable the acquisition of high-resolution images.

In FIG. 3, each pixel 30 of the focal point detection sensor 117 includes a photoelectric conversion unit 1 constituted by a MOS transistor gate and a depletion layer below the gate, a photogate 2, and a transfer switch MOS transistor 3. Furthermore, a reset MOS transistor 4, a source-follower amplifier MOS transistor 5, and a horizontal selection switch MOS transistor 6 are included in every other pixel. Furthermore, in each pixel column, a source-follower load MOS transistor 7, an output transfer MOS transistor 9, and a column AD circuit (column AD conversion circuit) 13 are disposed. A DFE circuit 14 is connected to the column AD circuit 13. Readout rows are selected by a vertical scanning circuit 15.

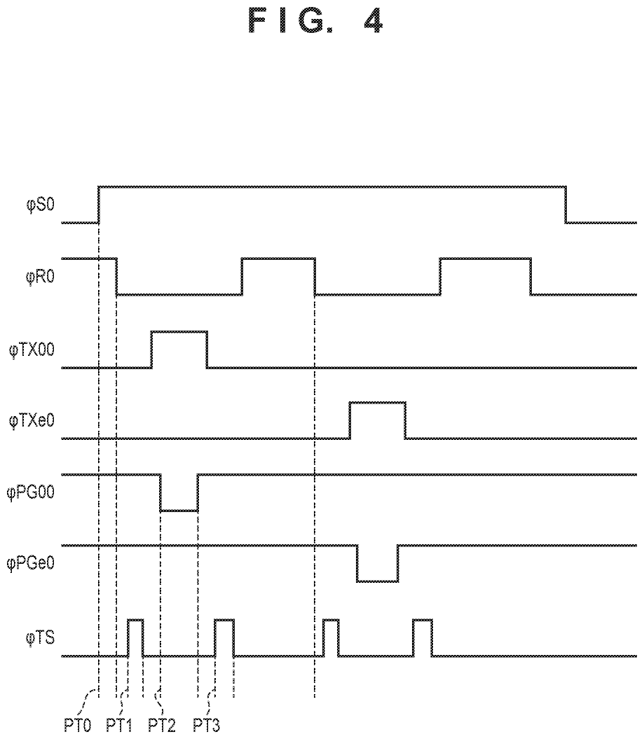

Next, FIG. 4 is a timing chart illustrating the operations of the focal point detection sensor 117. The operations of the focal point detection sensor 117 will be described using FIGS. 3 and 4.

First, due to output from the vertical scanning circuit 15, a control pulse φL, is switched to high and vertical output lines are reset. Furthermore, control pulses φR0, φPG00, and φPGe0 are switched to high, and reset MOS transistors 4 are switched on and the electric charge in photogates 2 is also reset.

At time PT0, a control pulse φS0 is switched to high to switch on selection switch MOS transistors 6 and select FD parts 21 of the first and second rows. Next, the control pulse φR0 is switched to low to stop the resetting of the FD parts 21 and place the FD parts 21 in a floating state, and the state between the gate and source of the source-follower amplifier MOS transistors 5 is switched to a through state. Subsequently, at time PT1, a control pulse φTS is switched to high to switch on the output transfer MOS transistors 9 and to make the output transfer MOS transistors 9 output the dark voltages of the FD parts 21 to the column AD circuit 13 according to a source follower operation. Then, the dark outputs of the FD parts 21 are converted into digital signals by the column AD circuit 13, and data N of dark voltage values converted into digital signals is temporarily stored by the DFE circuit 14.

Next, in order to perform photoelectric conversion on output from pixel 30-11 and pixel 30-12 in the first row, a control pulse φTX00 for the first row is switched to high to switch on transfer switch MOS transistors 3, and then, the control pulse φPG00 is switched to low at time PT2. Here, it is preferable to adopt a voltage relationship such as a voltage relationship that raises the potential wells spreading beneath the photogates 2 and causes the light generation carriers to be completely transferred to the FD parts 21.

At time PT2, as a result of the electric charge from photoelectric conversion units 1, which are constituted by photodiodes, being transferred to the FD parts 21, the electric potentials of the FD parts 21 change in accordance with the light-receiving amounts of the photoelectric conversion units 1. Here, because the source-follower amplifier MOS transistors 5 are in the floating state, the control pulse φTS is switched on at time PT3 to output the electric potentials of the FD parts 21 to the column AD circuit 13, and the bright outputs are converted into digital signals. Data S of bright output voltage values converted into digital signals is processed by the DFE circuit 14 performing an S/N ratio calculation, and pixel signals with reduced random noise and fixed pattern noise are obtained.

Furthermore, the bright output data S and the dark output data N from the pixels 30-11 and 30-12 are digitally converted simultaneously by the column AD circuit 13, and an S/N ratio is calculated by the DFE circuit 14. Digital data obtained by subtracting the converted dark output from the converted bright output is output to the CPU 102, with the pulse timing controlled by the DFE circuit 14.

After the bright output S is output to the column AD circuit 13, the control pulse φR0 is switched to high to place the reset MOS transistors 4 in a conducting state, and the FD parts 21 are reset to a power source voltage VDD. After the output of the digital data from the first row is finished, reading out of the line in the second row is performed. The reading out for pixel 30-21 and pixel 30-22 in the second row is performed by simultaneously driving a control pulse φTXe0 and a control pulse φPGe0, supplying a high pulse to the control pulse φTS, and taking out dark output data N and bright output data S. As a result of driving being performed as described above, reading out of the first row and the reading out of the second row can be performed independently from one another.

Following this, independent output from all of the pixels can be performed by subsequently causing the vertical scanning circuit 15 to perform a scan and similarly performing reading out of the (2n+1)th and (2n+2)th (n=1, 2, . . . ) rows. That is, if n=1, pixel signals of pixels 30-31 and 30-32 are read out by first switching a control pulse φS1 to high and then switching a control pulse φR1 to low, subsequently switching control pulses φTS and φTX01 to high, and switching a control pulse φPG01 to low and switching the control pulse φTS to high. Subsequently, pixel signals of pixels 30-41 and 30-42 are read out by applying control pulses φTXe1 and φPGe1 and control pulses similar to those described above.

Here, the column AD circuit 13 is a known ramp circuit-type AD converter that uses a comparator to compare voltages output from pixels via a column output line with a ramp voltage. A pixel signal is converted into a digital signal by activating an unillustrated counter when the comparison with the ramp voltage is started and measuring the time taken until the comparison result is reversed. If this configuration is adopted, there are cases where shot noise (referred to hereinafter as “lateral-stripe random noise”) is generated in the horizontal direction due to an error in the inclination of a ramp voltage and an error in the start timing of a counter, for example.

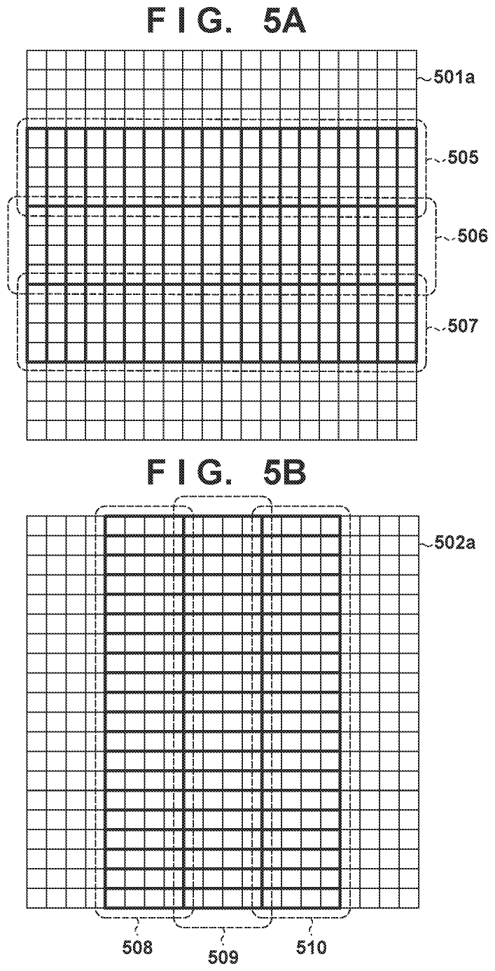

By performing the S/N ratio calculation using the DFE circuit 14 in FIG. 3, pixel signals with reduced random noise and reduced fixed-pattern noise can be obtained, but the S/N ratio decreases under a low luminance environment. In view of this, it is effective to perform pixel addition. Pixel addition methods will be described using FIGS. 5A to 5C.

FIGS. 5A to 5C are enlarged diagrams of imaging areas on the focal point detection sensor 117. In FIG. 5A, a pixel region of the imaging area 501a illustrated in FIG. 2 is illustrated in isolation. Here, one pixel for the correlation calculation, which is indicated in each pixel range enclosed in bold lines, is formed by adding four pixels in the vertical direction (pixel column direction). Furthermore, as A image line signals for the correlation calculation, which are enclosed by broken lines, signals of three lines, namely the lines 505, 506, and 507 are used. Similarly, three lines from the pixels in the imaging area 501b are used as B image line signals. First, the correlation calculation is performed for one line, and a correlation amount is calculated. Here, the correlation calculation disclosed in Japanese Patent No. 6254780 is performed. The amount of difference between the A image and the B image is calculated pixel by pixel while shifting the pixels, and the total of the amounts is adopted as the correlation amount. A correlation amount is similarly calculated for the other lines (i.e., the second and third lines). After the correlation amounts for three lines have been added up, the pixel shift amount for which the correlation amount is smallest is adopted as the calculation result of the phase difference. A defocus amount is calculated from this phase difference result.

In the case of the imaging areas 501a and 501b illustrated in FIG. 2, for which the correlation calculation direction is the horizontal direction, the addition of four pixels in the vertical direction can improve the S/N ratio not only with respect to pixel random noise but also with respect to lateral-stripe random noise generated in the horizontal direction. That is, by using the direction of the column output lines (vertical output lines), or that is, the direction in which pixel signals are transferred to the column AD circuit 13, as the direction in which pixels are added, the S/N ratio can be improved not only with respect to pixel random noise but also with respect to lateral-stripe random noise generated in the horizontal direction. Furthermore, the S/N ratio is also improved even if one line of units of twelve added pixels is used rather than three lines of units of four added pixels, but the contrast resolution decreases if the contrast of an object is obliquely distributed with respect to the direction in which pixels are added when one line of units of twelve added pixels is used. Thus, the detection accuracy is higher with three lines of units of four added pixels than with one line of units of twelve added pixels.

In FIG. 5B, a pixel region of the imaging area 502a illustrated in FIG. 2 is illustrated in isolation. Here, one pixel for the correlation calculation, which is indicated in each pixel range enclosed in bold lines, is formed by adding four pixels in the horizontal direction. Furthermore, as A image line signals for the correlation calculation, which are enclosed by broken lines, signals of three lines, namely the lines 508, 509, and 510 are used. Similarly, three lines from the pixels in the imaging area 502b are used as B image line signals.

In the case of the imaging areas 502a and 502b illustrated in FIG. 2, for which the correlation calculation direction is the vertical direction, the addition of four pixels in the horizontal direction can improve the S/N ratio with respect to pixel random noise. However, the addition of pixels does not have any effect with respect to lateral-stripe random noise generated in the horizontal direction. Thus, the focal point detection accuracy is lower compared to the case of the imaging areas 501a and 501b, for which the correlation calculation direction is the horizontal direction.

In FIG. 5C, a pixel region of the imaging area 503a illustrated in FIG. 2. for which the correlation calculation direction is an oblique direction, is illustrated in isolation. Here, one pixel for the correlation calculation, which is indicated in each pixel range enclosed in bold lines, is formed by adding four pixels in the vertical direction (predetermined direction), which differs from the above-described oblique direction and the direction perpendicular to the oblique direction. Furthermore, as A image line signals for the correlation calculation, which are enclosed by broken lines, signals of three lines, namely the lines 511, 512, and 513 are used. Similarly, three lines from the pixels in the imaging area 503b are used as B image line signals. Here, by adding four pixels in the vertical direction and not in the horizontal direction, a situation in which adjacent pixels come into contact with one another at one point is prevented.

Furthermore, similarly to the case of the imaging areas 501a and 501b illustrated in FIG. 5A, for which the correlation calculation direction is the horizontal direction, the addition of pixels in the vertical direction, or that is, the direction in which pixel signals are transferred to the column AD circuit 13, can improve the S/N ratio with respect to pixel random noise and also with respect to lateral-stripe random noise generated in the horizontal direction.

Furthermore, by adopting a parallelogram as the shape in which pixels are arranged if the first to third lines are combined, the line length L can be maximized with respect to the imaging areas. Accordingly, the amount of pixel shift when the calculation of the phase difference is performed is increased, and thus, the defocus detection range can be increased.

What is described in FIG. 5C similarly applies to the other pair of oblique-direction imaging areas 504a and 504b, and it suffices to add pixels in the vertical direction and to form lines in the correlation calculation direction (oblique direction).

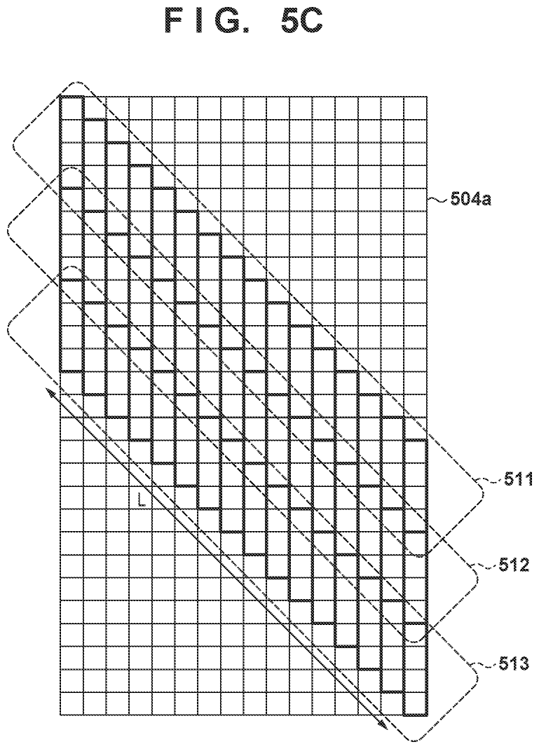

FIG. 6 is a flowchart illustrating the procedure of shooting control processing executed by the digital camera 100 of the present embodiment. The processing in FIG. 6 is executed by the CPU 102 executing one or more programs stored in the memory 103, and assumption is made of a case in which the digital camera 100 is already activated.

In step S101, the CPU 102 determines whether or not a switch SW1, which is switched on by a half-press of a shutter switch, has been switched on or not. If the switch SW1 is switched on, the CPU 102 proceeds to step S102, and if not, the CPU 102 waits without performing any processing.

In step S102, the CPU 102 controls the photometric sensor 108 and performs AE processing. Accordingly, photometric values including luminance information of an object in stationary light (referred to hereinafter as “photometric values in stationary light”) can be acquired. Furthermore, based on the photometric values in stationary light, exposure control values, such as the ISO sensitivity and the aperture value during shooting, and the accumulation time in the focal point detection sensor 117 are determined.

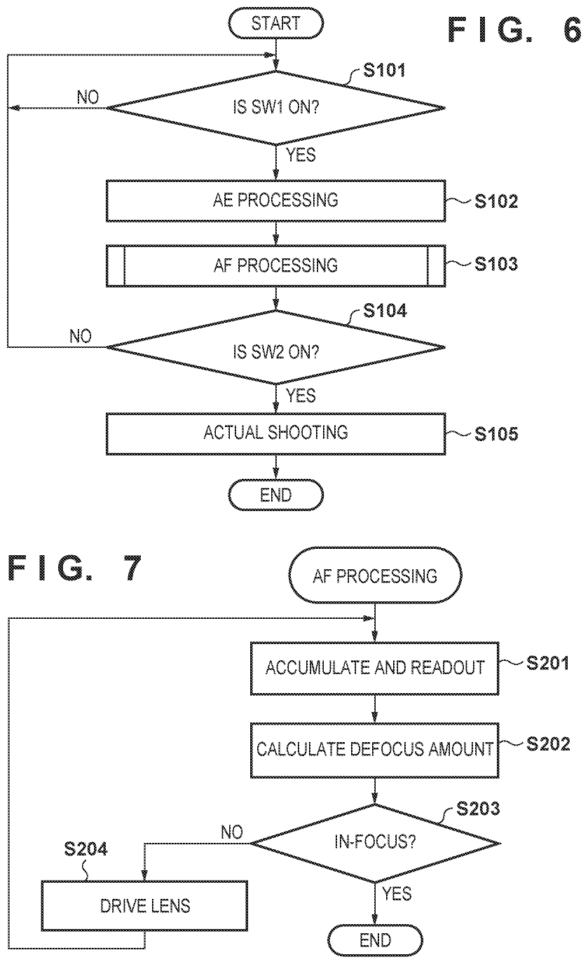

In step S103, the CPU 102 controls the focal point detection sensor 117 and performs phase difference autofocus (AF) processing. The CPU 102 transmits a calculated defocus amount to the LPU 151. As a result of this, the LPU 151 moves the lens group 152 to the focusing position based on the received defocus amount. Note that the details of the AF processing will be described later using the flowchart in FIG. 7.

In step S104, the CPU 102 determines whether or not a switch SW2, which is switched on by a full-press of the shutter switch, has been switched on or not. If the switch SW2 is switched on, the CPU 102 proceeds to step S105, and if not, the CPU 102 returns to step S101.

In step S105, the CPU 102 performs actual shooting, and the processing in the present flow is terminated.

FIG. 7 is a flowchart illustrating the procedure of the AF processing in step S103 in FIG. 6.

In step S201, the CPU 102 causes the focal point detection sensor 117 to perform an accumulation operation for the accumulation time determined based on the photometric values including the object luminance information acquired in step S102 in FIG. 6, and receives digital pixel data output from the focal point detection sensor 117. The operations of the focal point detection sensor 117 are as described above using FIGS. 3 and 4.

In step S202, the CPU 102 calculates the phase difference from pixel signals for individual imaging areas acquired in step S201, and calculates a defocus amount. The directions in which pixels in imaging areas are added, the method for forming the lines for correlation calculation, etc., are as described above in FIGS. 5A to 5C.

Here, defocus amounts for a plurality of correlation calculation directions are calculated, and a final defocus amount is acquired by performing averaging, weighted averaging, etc. Alternatively, a defocus amount for one of the plurality of correlation calculation directions may be selected. There is no particular limitation regarding the method of selection, but one correlation calculation direction can be selected for which it can be considered that the reliability of the defocus amount is high. The reliability of a defocus amount is considered as being high when the correlation between the waveforms of the pair of images is high, the contrast is high, etc.

In step S203, the CPU 102 determines whether or not the lens 150 is in an in-focus state. Specifically, the lens 150 is determined as being in-focus if the defocus amount calculated in step S202 is within a predetermined range, e.g., within 1/4Fδ (where F is the lens aperture value and δ is a constant (e.g., 20 μm)), for example. For example, in a case in which the lens aperture value F equals 2.0, the lens 150 is determined as being in-focus and the AF processing is terminated if the defocus amount is 10 μm or less.

On the other hand, if all defocus amounts are greater than 1/4Fδ in step S203, the CPU 102, in step S204, calculates a lens driving amount based on the defocus amount calculated in step S202 and instructs the lens 150 to drive the lens group 152. Then, the CPU 102 returns to the processing in step S201, and repeats the operations in steps S201 to S204 until the lens 150 is determined as being in the in-focus state.

As described above, the AF accuracy can be improved by adding pixels in the optimal direction for each imaging area having different correlation calculation directions and performing calculation.

### Second Embodiment

In the following, a second embodiment of the present invention will be described. The configuration of the digital camera of the second embodiment is similar to the configuration of the digital camera of the first embodiment, and thus, description of the configuration of the digital camera of the second embodiment is omitted. The second embodiment differs from the first embodiment in that focal point detection is performed by the image sensor 104. The image sensor 104 is a two-dimensional C-MOS area sensor, and has a circuit configuration similar to that of the focal point detection sensor 117.

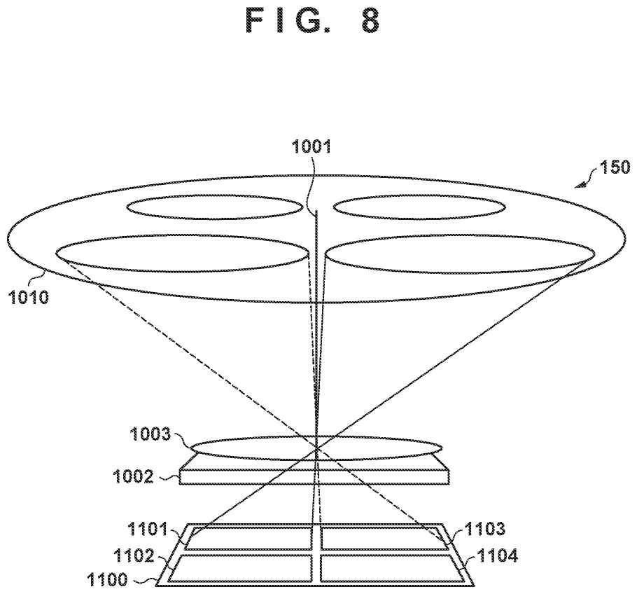

FIG. 8 is a schematic diagram illustrating a state in which light beams emitted from an emission pupil of the lens 150 enter a unit pixel of the image sensor 104.

In FIG. 8, a unit pixel 1100 includes 2×2 photodiodes, namely photodiodes 1101, 1102, 1103, and 1104. A color filter 1002 and a microlens 1003 are disposed in front of the unit pixel 1100. The lens 150 includes an emission pupil 1010. Given that the optical axis 1001 is at the center of the light beams emitted from the emission pupil 1010, the light passing through the emission pupil 1010 enters the unit pixel 1100 with the optical axis 1001 acting as the center.

The emission pupil 1010 of the lens 150 is divided by the 2×2 photodiodes, namely the photodiodes 1101, 1102, 1103, and 1104. Focal point detection is made possible by forming pairs of images while changing the combination of the photodiodes 1101, 1102, 1103, and 1104 receiving light entering from different pupil areas.

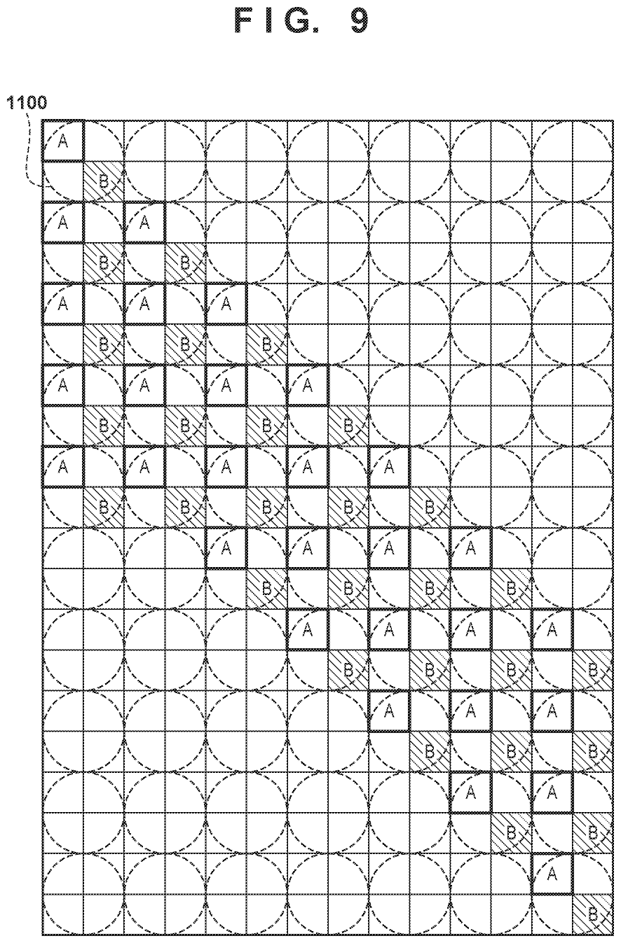

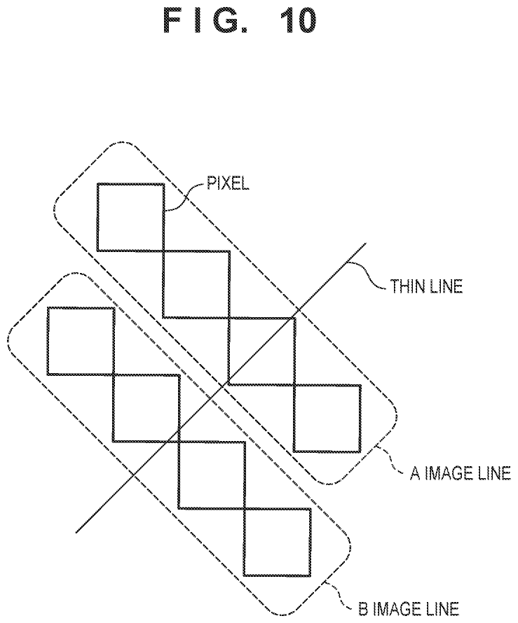

FIG. 9 is a plan view in which some of the plurality of pixels disposed in the image sensor 104 are illustrated in isolation. The 2×2 pixels enclosed in each round frame indicated by a broken line correspond to the unit pixel 1100. FIG. 9 illustrates the addition of pixels in a case in which the correlation calculation direction is an oblique direction, and corresponds to FIG. 5C in the first embodiment.

In FIG. 9, one pixel of the A image is formed by adding four pixels lining up in the vertical direction, which are enclosed in bold frames. Furthermore, one line of an A image line signal for the correlation calculation is formed by adding four pixels in the vertical direction in a similar manner while shifting pixels in an oblique direction that is the correlation calculation direction. One line of a B image line signal for the correlation calculation is formed by using hatched pixels as B images and adding the pixels four pixels at a time in the vertical direction while shifting pixels in the oblique direction that is the correlation calculation direction, similarly to the case of A images.

By forming the A image line signal and the B image line signal for the correlation calculation in such a manner, effects similar to those achieved in the case illustrated in FIG. 5C can also be achieved in an apparatus that performs focal point detection using the image sensor 104.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-047338, filed Mar. 14, 2019, which is hereby incorporated by reference herein in its entirety.

What is claimed is:

1. An image capturing apparatus comprising:
a two-dimensional imaging sensor having a first imaging area and a second imaging area respectively receiving light having passed through a first pupil area and a second pupil area that are obtained by dividing a pupil area of an imaging lens in a correlation calculation direction; and
at least one processor or circuit configured to function as a calculation unit configured to add pixels in the first imaging area in a predetermined direction that differs from two directions, which are the correlation calculation direction and a direction perpendicular to the correlation calculation direction, to form a first line signal in which the added pixels line up in the correlation calculation direction, to add pixels in the second imaging area in the predetermined direction to form a second line signal in which the added pixels line up in the correlation calculation direction, and to perform a correlation calculation using the first line signal and the second line signal.

2. The image capturing apparatus according to claim 1, wherein the calculation unit further calculates a defocus amount of the imaging lens from the result of the correlation calculation.

3. The image capturing apparatus according to claim 1, wherein the correlation calculation direction is an oblique direction relative to a horizontal direction of the image capturing apparatus.

4. The image capturing apparatus according to claim 3, wherein the correlation calculation direction is a diagonal direction of pixels.

5. The image capturing apparatus according to claim 1 further comprising AD conversion circuits configured to perform AD conversion on signals from the pixels,
wherein the predetermined direction is a direction in which signals of pixels are transferred to the AD conversion circuits.

6. The image capturing apparatus according to claim 5, wherein the AD conversion circuits are disposed one for each pixel column of the image sensor, and the predetermined direction is a column direction of the pixels.

7. The image capturing apparatus according to claim 1, wherein the calculation unit performs the correlation calculation by using a plurality of line signals in which the added pixels line up in the correlation calculation direction, and, based on a plurality of obtained correlation calculation results, calculates a phase difference as a result.

8. The image capturing apparatus according to claim 7, wherein the calculation unit calculates the phase difference as the result by performing averaging or weighted averaging of the plurality of correlation calculation results.

9. The image capturing apparatus according to claim 7, wherein pixels outputting the plurality of line signals are arranged in a substantially parallelogram shape.

10. The image capturing apparatus according to claim 1, wherein the calculation unit changes the predetermined direction in accordance with the correlation calculation direction.

11. The image capturing apparatus according to claim 1, wherein the image sensor is an image sensor for focal point detection.

12. The image capturing apparatus according to claim 1, wherein the image sensor is an image sensor in which a plurality of photoelectric conversion elements are disposed in one unit pixel.

13. A method for controlling an image capturing apparatus including a two-dimensional imaging sensor having a first imaging area and a second imaging area respectively receiving light having passed through a first pupil area and a second pupil area that are obtained by dividing a pupil area of an imaging lens in a correlation calculation direction, the method comprising:
adding pixels in the first imaging area in a predetermined direction that differs from two directions, which are the correlation calculation direction and a direction perpendicular to the correlation calculation direction, to form a first line signal in which the added pixels line up in the correlation calculation direction; adding pixels in the second imaging area in the predetermined direction to form a second line signal in which the added pixels line up in the correlation calculation direction; and performing a correlation calculation using the first line signal and the second line signal.

14. A non-transitory computer-readable storage medium storing a program for causing a computer to execute a method for controlling an image capturing apparatus including a two-dimensional imaging sensor having a first imaging area and a second imaging area respectively receiving light having passed through a first pupil area and a second pupil area that are obtained by dividing a pupil area of an imaging lens in a correlation calculation direction, the method comprising:
adding pixels in the first imaging area in a predetermined direction that differs from two directions, which are the correlation calculation direction and a direction perpendicular to the correlation calculation direction, to form a first line signal in which the added pixels line up in the correlation calculation direction; adding pixels in the second imaging area in the predetermined direction to form a second line signal in which the added pixels line up in the correlation calculation direction; and performing a correlation calculation using the first line signal and the second line signal.
